(19) United States
(12) Patent Application Publication
(10) Pub. No.: US 2014/0334491 A1
(43) Pub. Date: Nov. 13, 2014

(54) PREDICTION BASED METHODS FOR FAST ROUTING OF IP FLOWS USING COMMUNICATION/NETWORK PROCESSORS

(71) Applicant: LSI Corporation, San Jose, CA (US)

(72) Inventors: Benzeer B. Pazhayakath, Bangalore (IN); Vishal D. Ajmera, Bangalore (IN); Santosh Narayanan, Bangalore (IN)

(73) Assignee: LSI Corporation, San Jose, CA (US)

(21) Appl. No.: 14/244,122

(22) Filed: Apr. 3, 2014

(30) Foreign Application Priority Data
May 9, 2013 (IN) 531/KOL/2013

(51) Int. Cl. H04L 12/743

(52) U.S. Cl. CPC H04L 45/7453
USPC 370/392

(57) ABSTRACT

Aspects of the disclosure pertain to a system and method for providing prediction based, fast routing of IP flows. A hash table-based mechanism is implemented by the system such that classification information obtained and/or utilized for a first packet of an IP flow is applied to subsequent packets of the IP flow, thereby promoting packet processing efficiency for the flow.

### FIELD OF THE INVENTION

The present disclosure relates to the field of electronic data handling and particularly to prediction based methods for fast routing of Internet Protocol (IP) flows using communication/network processors.

### BACKGROUND

In hardware-based implementations of networking solutions using programmable network processors, there is a partitioning of data plane functions and control plane functions. Data plane implements packet switching and forwarding through multiple levels of lookups of combinations of different packet fields (e.g., classification). The latency involved in packet classification is often the gating factor for system throughput (e.g., packets per second).

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner

Aspects of the disclosure pertain to a system and method for providing prediction based, fast routing of IP flows.

### DESCRIPTION OF THE FIGURES

The detailed description is described with reference to the accompanying figures:

FIG. 1 is an example conceptual block diagram schematic of a network of networking systems (e.g., nodes);

FIG. 2 is an example conceptual block diagram schematic of a processor (e.g., network processor) implemented within one of the networking systems of the network shown in FIG. 1; and

FIG. 3 is a flow chart illustrating a method for processing a packet flow (e.g., IP flow) via a processor (e.g., network processor) in accordance with an exemplary embodiment of the present disclosure.

### WRITTEN DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be facilitated by methods, devices, and/or embodied in articles of commerce. The following detailed description is, therefore, not to be taken in a limiting sense.

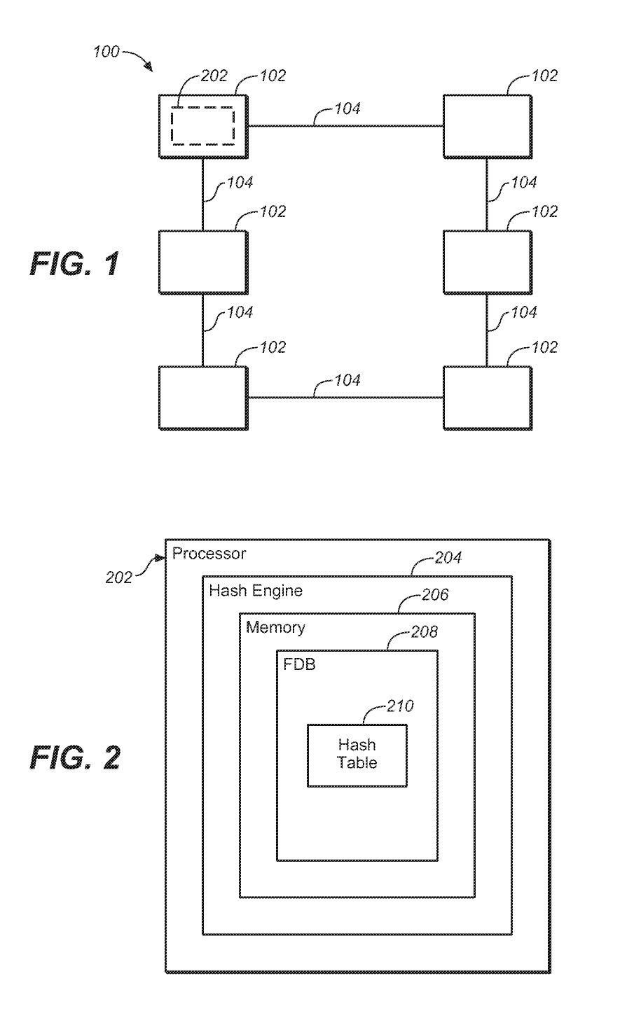

Referring to FIG. 1 (FIG. 1), a network 100 is shown. In embodiments, the network 100 is a telecommunications network, such as a computer network. In embodiments, the network 100 includes a plurality of networking systems 102. In embodiments, the networking systems 102 are terminals (e.g., computer terminals), nodes, and/or devices which are configured for being communicatively coupled via a plurality of communication links (e.g., data links, transmission links, communications channels) 104. In embodiments, the terminals are points at which signals (e.g., data) enter or leave the network 100, and/or are devices which end a telecommunications link. In embodiments, the networking systems 102 are configured for connecting via the communication links 104 to enable telecommunication between users of the terminals.

In embodiments, the network 100 is a packet switching network (e.g., a packet network, a packet mode computer network). In embodiments, the networking systems (e.g., nodes) 102 implement packet switching for passing signals (e.g., data) through the correct links 104 and nodes to reach the correct destination (e.g., terminal, destination terminal). In embodiments, each terminal in the network 100 has a unique address so that signals, data, messages, and/or connections can be routed to a correct destination (e.g., recipient). In embodiments, the collection of addresses in the network 100 constitutes the network address space. In embodiments, packet switching is a digital networking communications method which groups all transmitted data, regardless of content, type, or structure, into suitably-sized blocks or packets. In embodiments, information (e.g., voice, video, or data) is transferred (e.g., transmitted) via the network 100 as packet data, via packet switching. In embodiments, the network 100 transmits (e.g., transfers, carries) packets, each packet being a formatted unit of data carried (e.g., transmitted) by the packet switching network.

In embodiments, the network 100 is a computer network that connects a collection of different or similar types of computers and networks to allow communication and data exchange between systems, software application, and users. Endpoints (e.g., computers, nodes) of the computer network each have a unique location identity. Interconnection of the computers of the computer network is done via cable and/or wireless media and/or networking hardware devices.

In embodiments, one or more of the networking systems 102 of the network 100 is a router, software router, switch, firewall, session border controller, intrusion prevention/detection device, network monitoring system, base station (e.g., Long Term Evolution (LTE) base station), and/or mobile device (e.g., a mobile backhaul router). In embodiments, the network 100 is a mobile backhaul based network. In embodiments in which the network 100 is a mobile backhaul based network, one or more of the networking systems 102 are mobile devices. In embodiments in which the network 100 is a mobile backhaul based network, one or more of the networking systems 102 is a mobile backhaul router which is configured for routing data and connection signaling packets to a mobile backbone via the network (e.g., packet network) 100.

In embodiments, one or more of the networking systems 102 of the network 100 includes a processor 202, such as a network processor or a communications processor (as shown in FIG. 2 (FIG. 2)). In embodiments, the processor (e.g., network processor) 202 is an integrated circuit having a feature set specifically targeted at the networking application domain. In embodiments, the network processor 202 is a software-programmable device configured for processing packet data (e.g., packets). In embodiments, when networking system 102 implementing the network processor 202 receives a packet, the processor 202 is configured for processing the packet and routing the packet to its destination. In embodiments, the processor (e.g., network processor) 202 is configured with specific features and/or architectures that are provided to enhance and optimize processing of packet data (e.g., packets) in packet switching networks. In embodiments, the processor 202 (e.g., network processor) is configured for performing one or more of the following optimized features or functions: pattern matching; key lookup; computation; data bitfield manipulation; queue management; control processing; traffic management and quick allocation/re-circulation of packet buffers. In embodiments, a software program running on the network processor 202 may implement an application that the network processor 202 executes, resulting in the networking system (e.g., device) 102 performing a task or providing a service. For example, some of the application types that are implemented as software running on the network processor 202 may include: packet or frame discrimination and forwarding; Quality of Service (QoS) enforcement; access control functions; encryption; and Transmission Control Protocol (TCP) offload processing.

In embodiments, one or more of the networking systems 102 are configured for receiving and processing a packet flow (e.g., an Internet Protocol (IP) flow) including a plurality (e.g., a large number) of packets. In embodiments, the network processor 202 of the networking system 102 is configured for processing the packets of the packet flow (IP flow). In embodiments, the network processor 202 is configured for parsing each packet of the packet flow and extracting fields (e.g., relevant fields) from that packet. In embodiments, the network processor 202 is further configured for validating the extracted fields of the packet. In embodiments, the network processor 202 is configured for performing metering, access control filtering and other control functions. In embodiments, the network processor 202 is further configured for performing a series of (e.g., multiple) table lookups of various sets of (e.g., a combination of different) fields for a first packet (e.g., a first processed packet, a first received packet) included in the plurality of packets of the packet flow, to determine a destination (e.g., destination node, destination terminal) for the first packet. In embodiments, the network processor 202 (e.g., network processor hardware) internally realizes lookups through Longest Prefix Match (LPM) tries. In embodiments, one lookup type of special interest is the ordered lookup with range patterns. However, this lookup type is expensive in terms of the processing cycles involved in the lookup. In embodiments, the network processor 202 (e.g., the network processor hardware) internally implements ordered lookups such as Policy Based Routing (PBR) and/or Access Control Lists (ACL) as Longest Prefix Match (LPM) tries.

In embodiments, the network processor 202 performs an optional ingress ACL lookup, followed by a PBR table lookup. In embodiments, the network processor 202 performs ACL lookup when the traffic (e.g., the first packet) is from an untrusted or core network side. In embodiments, in the network processor 202, ACL and PBR tables have multi-field matching capability and are thus implemented using OVTREESET based trees. In embodiments, the OVTREESET based trees include a set of sub-trees, each sub-tree of the set of sub-trees having a separate lookup for each of the fields. In embodiments, each sub-tree returns a virtual handle. In embodiments, the final tree lookup includes a set of virtual handles (e.g., as the inputs) and returns the next hop identification (ID) or address. Thus, if there are N input fields in the tree, there are N+1 table lookups. In embodiments, the cycles involved depend upon the placement of the tree in memory of the networking system 102. In embodiments, the ACL or PBR lookup from a rule table with N fields involves: N lookups for each of the fields to convert them to a virtual pattern; and one LPM lookup of the virtual pattern. In embodiments in which both ACL and PBR are enabled for the IP flow, the cost of lookup doubles. In embodiments, the network processor 202 is further configured for performing post-classification table lookups and egress processing (e.g., for the first packet). In embodiments, the network processor 202 is further configured for transmitting packets (e.g., the first packet) to a destination (e.g., egress) interface.

As mentioned above, the network processor 202 is configured for receiving and processing a packet flow (e.g., an Internet Protocol (IP) flow) including a plurality (e.g., a large number) of packets. In embodiments, in the networking system 102 (e.g., router, LTE base station), the probability of packets with a same destination (e.g., destiny) appearing as clusters is quite high. For example, such a scenario would be when a file transfer occurs where a train of datagrams from a same socket are sent out with a same IP and User Datagram Protocol (UDP)/Transmission Control Protocol (TCP) headers which arrives in a short time span. In some embodiments, the networking system 102 receives multiple groups of such flows (e.g., IP flows) in a given time interval. In a number of applications, such as when the network 100 is a mobile backhaul-based network wherein a lot of mobile devices are downloading rich content, the probability of the reappearance of packets having the same destination within a micro-interval is quite high.

Described above are exemplary processing steps implemented by the network processor 202 when processing a first packet in an IP flow. However, as mentioned above, one of the exemplary processing steps when processing the first packet of the flow includes implementing ordered lookups (e.g., ACL lookups, PBR lookups), which are expensive in terms of the processing cycles involved. In embodiments, subsequent packets of the IP flow have relevant fields which are the same as the first packet (e.g., the relevant fields are repeated across a large number of packets received within an interval; one or more of the subsequent packets of the IP flow have a same destination as the first packet). In embodiments, the network processor 202 of the present disclosure is configured for applying historic data to (e.g., implementing principles of history-based predictive routing for) the subsequent packets of the flow (e.g., IP flow) instead of performing the ordered lookups for the subsequent packets of the flow. By applying historic data to the subsequent (e.g., later received, later processed) packets of the flow rather than repeating the resource-expensive ordered lookups which were performed when processing the first packet of the flow, the network processor 202 promotes increased throughput and improved Quality of Service (QoS) (e.g., end-to-end latency improvement) for the processor 202, the networking system 102 and the network 100. In embodiments, a number of IP flows existing in (e.g., received by) the networking system 102 are of a reasonably long duration. In embodiments, the network processor 202 of the system 102 is configured for utilizing the classification (e.g., decision) used for the first packet of the flow for all of the subsequent packets of the flow, thereby promoting savings in packet processing, which translates into throughput improvement, which is beneficial, even if by a small factor.

In embodiments, the processor (e.g., network processor) 202 includes a hash engine (e.g., a hardware-based hash engine) 204. In embodiments, the network processor 202 further includes a memory (e.g., hash engine memory, internal memory) 206. In embodiments, the hash engine 204 is utilized by network processor 202 for implementing the history-based (e.g., predictive) routing features described herein.

In embodiments, the networking system 102 is an Ethernet-based device. In embodiments, the processor 202 (e.g., network processor) is configured for providing wire-speed processing (e.g., learning) and forwarding of packets in a data plane of the processor. In embodiments, a forwarding database (FDB) 208 (e.g., FDB table) is maintained in the memory (e.g., hash engine memory) 206 of the processor 202. In embodiments, the processor 202 is configured for supporting wire-speed processing (e.g., learning) of Media Access Control (MAC) addresses in the data plane without any intervention of the control plane. The processor 202 achieves this by utilizing the hardware-based hash engine 204. In embodiments, the FDB 208 (e.g., learning tables) maintained in the hash engine 204 (e.g., hash engine memory 206) are updated using data plane packet processing software.

In embodiments, when a new MAC address is received (e.g., detected) by the processor 202, a new entry is created in the FDB 208 (e.g., learning table(s)) and an associated aging timer is started, the new entry automatically aging out when the timer expires. In embodiments, if a packet having a known MAC address was received by the processor 202, this would cause the aging timer to be reset. In embodiments, when the aging timer expires, the entry (e.g., MAC address) is removed from the learning table. In embodiments, all of these operations are supported in the data plane of the network processor 202 at wire-speed. In embodiments, MAC learning (e.g., processing) and forwarding (e.g., MAC address learning and forwarding) are performed by the processor 202 in the context of Virtual Local Area Networks (VLANs). In embodiments, for every entry addition in the FDB 208, the processor 202 is configured for sending a notification to the control plane to ensure that the FDB 208 seen by the operator is in sync with what is available in the data plane.

In embodiments, the FDB 208 of the processor 202 includes learning and forwarding tables (e.g., MAC learning and forwarding tables, a hash table) which are maintained in the data plane. In embodiments, in order to facilitate wire speed switching, operations of the forwarding database (FDB) 208 of the processor 202, such as processing (e.g., learning), aging and flushing are managed in the data plane. In embodiments, the control plane is only notified by the processor 202 of any changes in the FDB 208, so as to keep the operator's view of the FDB 208 in sync with the data plane. In embodiments, the processor 202 implements a hash table-based design for the FDB 208 (e.g., the FDB 208 includes a hash table 210).

In embodiments, for subsequent packets (e.g., packets other than the first received/first processed packet) of the flow (e.g., IP flow), rather than using the ordered lookups (e.g., tree lookups) described above, the network processor 202 is configured for utilizing a hash-based lookup. In embodiments, the hash engine 204 of the network processor 202 is configured for determining (e.g., learning) a particular pattern associated with the packets of the IP flow and further hash lookups return the output associated with that particular pattern (e.g., hash pattern). In embodiments, the hash engine 204 is configured for determining (e.g., learning) a pre-determined (e.g., desired) ACL or PBR input pattern, returning an action and, if applicable, returning the next hop ID or address. In embodiments, the hash pattern(s) are configurable (e.g., programmed) to have a fixed lifetime by configuring a hash timer. In embodiments, the hash table 210 includes an input signature function, which is used before using ACL and PBR lookups. In embodiments, the signature function (e.g., input signature function) includes an entire set of input patterns which were used in ACL or PBR lookups (e.g., performed for the first packet of the flow), or a subset thereof. In embodiments, the network processor 202 is configurable such that the choice of signature function is configurable on a per IP interface basis by an application being executed by the processor 202.

In embodiments, as mentioned above, the network processor 202 is configured for processing packets of a flow (e.g., an IP flow). For example, the IP flow is received via a certain IP interface “A”, the IP flow having the following characteristics: IP Source Address 10.10.10.11; IP Destination Address 11.11.11.10; Protocol=TCP; TCP Destination Port=200; TCP Service Port=500; DCSP=20. In embodiments, the network processor 202 is configured for receiving a first packet of the IP flow. In embodiments, the network processor 202 is configured for extracting fields of the first packet (e.g., as per the signature function). For example, the extracted fields include the following six fields: IP Source Address 10.10.10.11; IP Destination Address 11.11.11.10; Protocol=TCP; TCP Destination Port=200; TCP Service Port=500; DCSP=20. In embodiments, the processor 202 is configured for performing a hash lookup for the first packet. For example, selectors used for hashing include all six fields mentioned above. In embodiments, the hash lookup for the first packet of the IP flow will not result in a match (e.g., matching entry) being located in the hash table 210. As a result, the processor 202 is configured for causing ordered lookup(s) (e.g., PBR and/or ACL table lookups) to be performed for the first packet for determining a destination of the first packet. For example, a PBR table is consulted, resulting in the following routing (e.g., destination) information being obtained: Next Hop ID: 250; Action=Forward. Concurrently, a hash learning mechanism is initiated by the hash engine 204, so that the particular IP flow being processed is determined (e.g., learned) by the hash table 210. For example, the hash table 210 associates the destination information obtained from the PBR table for the first packet with the extracted fields of the first packet. In embodiments, for subsequent (e.g., all subsequent) packets of the IP flow, the processor 202 is configured for retrieving the destination/routing information (e.g., Next Hop ID and Action) obtained for the first packet of the flow from the hash table 210, rather than performing the expensive ordered lookups (e.g., rather than consulting the PBR table). This eliminates the need for implementing costly PBR and/or ACL table lookups for subsequent packets of the flow.

In embodiments, the hash table 210 is configured to have a fixed size so that it fits inside the internal memory 204 of the processor 202. In embodiments, the processor 202 is configured for implementing a hash timer for ensuring that stale entries corresponding to expired (e.g., timed out, old) IP flows are removed from the hash table 210. In embodiments, when the amount of active flows exceeds the size (e.g., storage capacity) of the hash table 210, entries that are not present in the hash table will proceed to the ordered lookup (e.g., PBR) table. The choice of hash timer is crucial for the effectiveness of the small-sized hash table. In embodiments, the hash timer entry is selected per hash table entry. For example, if the chosen hash timer value is too small, then the hash entry will be removed from the hash table 210 if there's a brief lull in traffic from that flow. Further, if the chosen hash timer value is too large, the hash entry will remain in the hash table longer than necessary. In embodiments, the selected hash timer value is matched to the dwell time of the flow. In embodiments, aside from deletion of hash table entries when the hash timer expires, there are other situations when hash table entries are removed, such as via an Application Programming Interface (API) by the control plane when there is an ordered lookup (e.g., PBR or ACL) table update.

As described above, the processor 202 implements a hash table-based mechanism for identifying (e.g., determining, learning about) a packet flow during processing of a first packet of the flow and applying routing/destination data (e.g., action, decision) obtained for the first packet to all subsequent packets of the flow, thereby promoting faster routing of the packets by the processor 202. The hash table-based mechanism (e.g., application) is configured for choosing the signature function that will be used in the hash-based match. Further, the hash table-based mechanism allows for application-level configurability of the hash timer based on statistical analysis of the lifetimes of IP flows. Still further, the hash table 210 implemented by the hash table-based mechanism is sized for promoting faster lookups compared to tables used for ordered lookups, and without the cost and thrashing issues associated with the ordered lookups. Further, the network processor 202 is configured for implementing the hash engine 204, as described herein, to provide a route caching mechanism which speeds up IP packet processing. In embodiments, the hash engine 204 serves the purpose of a cache without incurring the cost of a hardware cache. In embodiments, the network processor 202 is configured for defining (e.g., performing) a set of predictive routing methods based upon dynamic correlation of received packets and is further configured for applying lookup results for a previous packet of a corresponding flow to subsequent packets of the corresponding flow.

In embodiments, the network processor 202 is configured for receiving a cluster of segments of a huge file or a media streaming application from a same layer 4 socket. In such embodiments, relevant packet fields remain the same for packets of a flow, and hence, the destination of those packets remains the same. In such embodiments, the network processor 202 is configured for re-using cached historic data corresponding to a destination of a first packet of the flow, so that the amount of lookup cost can be minimized for subsequent packets of the flow (e.g., of the same type). This promotes reduced average classification latency. For example, the networking system 102 (e.g., the network processor 202 of the networking system) may receive N packets in time interval t. Further, the N packets include: n1 packets of type 1, n2 packets of type 2, and n3 packets of type 3. In embodiments, the network processor 202 is configured for re-using a conclusion corresponding to a first packet of the n1 packets of type 1 for the remaining n1-1 packets which arrive within time interval t. In embodiments, the network processor 202 is further configured for re-using a conclusion corresponding to a first packet of the n2 packets of type 2 for the remaining n2-1 packets which arrive within time interval t. In embodiments, the network processor 202 is further configured for re-using a conclusion corresponding to a first packet of the n3 packets of type 3 for the remaining n3-1 packets which arrive within time interval t. In embodiments, since the fields which determine a specific destination (e.g., destiny) of a packet may be a specific subset of a combination of fields, there can be more than one packet type that has the same destination (e.g., destiny, fate). In embodiments, the network processor 202 is configured for dynamically deriving a unique signature at low computing cost to serve as a cache key for providing history-based routing.

As mentioned above, the networking system 102 is configured for receiving multiple groups of flows within a given time interval. The dwell time or lifetime of such flows is significant enough to benefit from any savings in successive lookups. In embodiments, the multiple groups of flows are interleaved in time. In embodiments, the processor 202 is configured for processing the interleaved flows without issue. For example, the hash table 210 matches all entries present in the table. In embodiments, the mechanisms which remove entries from the hash table 210 include hash table ageing and explicit deletion initiated by the control plane.

In embodiments, the hash table-based mechanism implemented by the network processor 202 promotes processing savings by avoiding ACL and PBR lookups for subsequent packets of a flow. For example, the savings is a total of 2N+2 lookups (minus the cycles needed for hash lookup) and is appreciable when the IP flows have long lifetimes. Along with promoting improved packet processing savings, the hash table-based mechanism implemented by the network processor 202 promotes increased throughput performance and promotes reduction in end-to-end packet delay.

In embodiments, the network processor 202, via the hash table-based mechanism, is configured for allowing a user to create user-defined signature functions for defining IP flows. In embodiments, the network processor 202 is further configured for performing a timed hash of a flow signature that contains historic conclusions, and, if a historic conclusion exists, allows for bypass of expensive lookups. In embodiments, the networking system 102 is configured for invalidating flows on forwarding plane changes. In embodiments, the network processor 202, via the hash table-based mechanism, is configured for implementing multiple signature functions with smaller or larger numbers of fields based on application preference

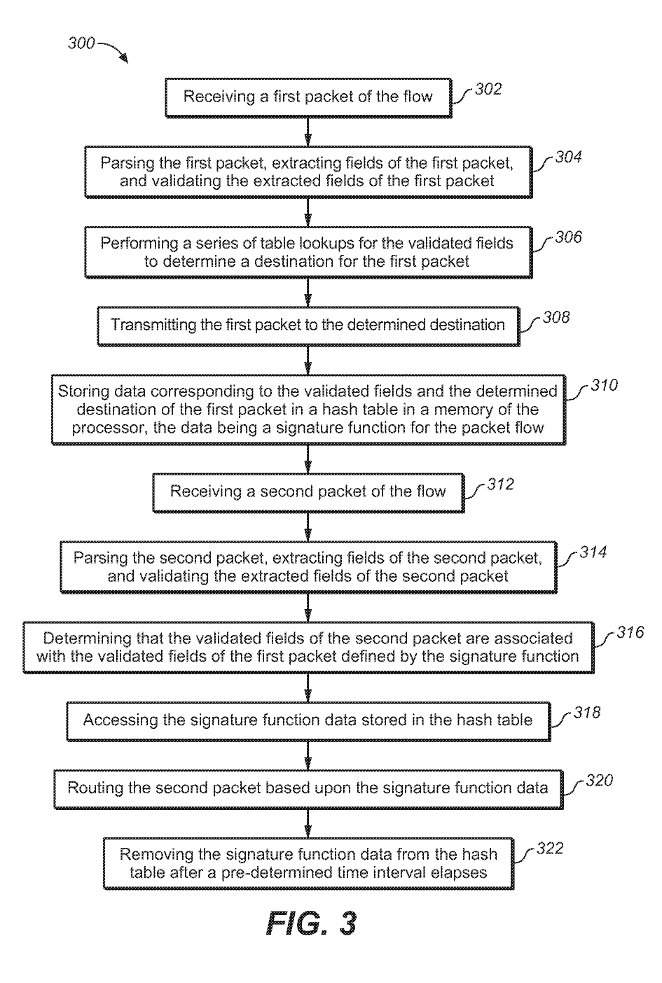

FIG. 3 is a flowchart illustrating a method for processing a packet flow (e.g., IP flow) via a processor (e.g., network processor) 202 in accordance with an embodiment of the present disclosure. In embodiments, the method 300 includes a step of receiving a first packet of the flow (Step 302). In embodiments, the method 300 further includes a step of parsing the first packet, extracting fields of the first packet, and validating the extracted fields of the first packet. (Step 304). In embodiments, the processor 202 is configured for discarding the packet if the fields are invalid. In embodiments, the method 300 further includes a step of performing a series of table lookups for the validated fields to determine a destination for the first packet. (Step 306). For example, the processor 202 performs a series of ordered lookups (e.g., ACL and/or PBR lookups, classification) for the validated fields to determine a destination for the first packet. In embodiments, the method 300 further includes a step of transmitting the first packet to the determined destination (Step 308). In embodiments, the method 300 further includes a step of storing data corresponding to the validated fields and the determined destination of the first packet in a hash table in a memory of the processor, the data being a signature function for the packet flow (Step 310). For example, the signature function defines a set of packet fields fed as an input to the hash table 210 to form a unique signature for packets with the same relevant fields.

In embodiments, the method 300 further includes a step of receiving a second packet of the flow. (Step 312). In embodiments, the method 300 further includes a step of parsing the second packet, extracting fields of the second packet, and validating the extracted fields of the second packet (Step 314). In embodiments, the method 300 further includes a step of determining that the validated fields of the second packet are associated with (e.g., match, are compatible with) the validated fields of the first packet defined by the signature function (Step 316). In embodiments, the method 300 further includes a step of accessing the signature function data stored in the hash table (Step 318). For example, rather than performing the series of ordered lookups for the second packet, the signature function data is accessed from the hash table and applied to the second packet. In embodiments, the method 300 further includes a step of routing the second packet based upon the signature function data (Step 320). For example, the second packet is routed to the same destination as the first packet, based upon the signature function data, which includes an action and a next hop ID.

In embodiments, the method 300 further includes a step of removing the signature function data from the hash table after a pre-determined time interval elapses (Step 322). For example, a hash timer is set for a pre-determined time interval, and once that time interval elapses (e.g., the signature function data corresponding to the flow becomes associated with an expired flow), the processor 202 removes the signature function data from the hash table 210.

It is to be noted that the foregoing described embodiments may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the embodiments described herein may be conveniently implemented in forms of a software package. Such a software package may be a computer program product which employs a non-transitory computer-readable storage medium including stored computer code which is used to program a computer to perform the disclosed functions and processes disclosed herein. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for processing a packet flow via a processor, the method comprising:
receiving a first packet of the flow;
parsing the first packet, extracting fields of the first packet, and validating the extracted fields of the first packet;
performing a series of table lookups for the validated fields to determine a destination for the first packet;
transmitting the first packet to the determined destination; and
storing data corresponding to the validated fields and the determined destination of the first packet in a hash table in a memory of the processor, the data being a signature function for the packet flow.

2. The method as claimed in claim 1, further comprising:
receiving a second packet of the flow.

3. The method as claimed in claim 2, further comprising:
parsing the second packet, extracting fields of the second packet, and validating the extracted fields of the second packet.

4. The method as claimed in claim 3, further comprising:
determining that the validated fields of the second packet are associated with the validated fields of the first packet defined by the signature function.

5. The method as claimed in claim 4, further comprising:
accessing the signature function data stored in the hash table.

6. The method as claimed in claim 5, further comprising:
routing the second packet based upon the signature function data.

7. The method as claimed in claim 6, further comprising:
removing the signature function data from the hash table after a pre-determined time interval elapses.

8. The method as claimed in claim 1, wherein the processor is one of: a network processor and a communications processor.

9. The method as claimed in claim 1, wherein the packet flow is an Internet Protocol packet flow.

10. The method as claimed in claim 1, wherein the table lookups are one of: Policy Based Routing lookups and Access Control Lists lookups.

11. The method as claimed in claim 6, wherein the second packet is routed to the destination of the first packet.

12. The method as claimed in claim 6, wherein the signature function data includes at least one of: an action and a next hop identification.

13. A non-transitory computer-readable medium having computer-executable instructions for performing a method for processing a packet flow via a processor, the method comprising:
receiving a first packet of the packet flow;
parsing the first packet, extracting fields of the first packet, and validating the extracted fields of the first packet;
performing a series of table lookups for the validated fields to determine a destination for the first packet, the table lookups including Policy Based Routing lookups;
transmitting the first packet to the determined destination; and
storing data corresponding to the validated fields and the determined destination of the first packet in a hash table in a memory of the processor, the data being a signature function for the packet flow.

14. The non-transitory computer-readable medium as claimed in claim 13, the method further comprising:
receiving a second packet of the flow.

15. The non-transitory computer-readable medium as claimed in claim 14, the method further comprising:
parsing the second packet, extracting fields of the second packet, and validating the extracted fields of the second packet.

16. The non-transitory computer-readable medium as claimed in claim 15, the method further comprising:
determining that the validated fields of the second packet are associated with the validated fields of the first packet defined by the signature function.

17. The non-transitory computer-readable medium as claimed in claim 16, the method further comprising:
accessing the signature function data stored in the hash table, the signature data including at least one of: an action and a next hop identification.

18. The non-transitory computer-readable medium as claimed in claim 17, the method further comprising:
routing the second packet based upon the signature function data, including: routing the second packet to the destination of the first packet.

19. The non-transitory computer-readable medium as claimed in claim 18, the method further comprising:
removing the signature function data from the hash table after a pre-determined time interval elapses.

20. A networking system, comprising:
a network processor, the network processor including a memory; and
control programming configured for causing the processor to execute a hash engine-based method for processing a packet flow, the method including the steps of: receiving a packet of the flow; parsing the packet, extracting fields of the packet, and validating the extracted fields of the packet; determining that the validated fields of the packet are associated with validated fields associated with an earlier received packet of the flow; accessing signature function data stored in a hash table in the memory of the processor, the signature function data corresponding to the validated fields and a determined destination of the earlier received packet of the flow; and routing the packet to the destination based upon the stored signature function data,
wherein the signature function data includes at least one of: an action and a next hop identification.
